(19) United States
(12) Patent Application Publication
(10) Pub. No.: US 2015/0124067 A1
(43) Pub. Date: May 7, 2015

(54) PHYSIOLOGICAL MEASUREMENT OBTAINED FROM VIDEO IMAGES CAPTURED BY A CAMERA OF A HANDHELD DEVICE

(71) Applicant: Xerox Corporation, Norwalk, CT (US)

(72) Inventors: Raja BALA, Pittsford, NY (US); Beilei XU, Penfield, NY (US); Lalit Keshav MESTHA, Fairport, NY (US); Graham S. PENNINGTON, Webster, NY (US); Stuart A. SCHWEID, Pittsford, NY (US)

(73) Assignee: Xerox Corporation, Norwalk, CT (US)

(21) Appl. No.: 14/071,355

(22) Filed: Nov. 4, 2013

(51) Int. Cl. H04N 5/235; H04N 7/18; G06T 7/00; G06K 9/00

(52) U.S. Cl. CPC H04N 5/2354; G06K 9/00362; H04N 7/18; G06T 7/0012
USPC 348/77

(57) ABSTRACT

What is disclosed is a handheld device having at least one illuminator for projecting source light and a video camera for capturing images of a region of interest of a subject being monitored for a desired physiological function. The handheld device is positioned such that light reflected off the subject's region of interest is received by a sensor. A determination is then made as to how a physiological signal extracted from video images captured by the video camera can be improved by an adjustment to the illuminator with respect to intensity, spectrally, spatially, and/or temporally, to improve accuracy of a measurement of a desired physiological function. The illuminator is adjusted and video images of a region of interest are captured by the video camera and processed to extract a physiological signal corresponding to that physiological function. That signal is used to monitor the desired physiological function. Various embodiments are disclosed.

### TECHNICAL FIELD

The present invention is directed to systems and methods which use a handheld device to capture video of a user under diverse lighting conditions such that health vitals of that user can be more accurately estimated from physiological signals obtained from having processed the captured video.

### BACKGROUND

Efforts have been expended in the domain of contact-less sensing of human health vitals where video is captured of a region of a patient and analyzed to estimate such vitals. One advantage over standard vitals monitoring techniques is the avoidance of contact measurement which may be a problem for fragile patients such as infants and the elderly who need monitoring for a long period of time. One challenge is that the illumination can vary considerably. Low or uneven lighting can result in poor quality images captured by that mobile device. An analysis of those images may therefore produce unreliable estimates of health vitals.

Accordingly, what is needed in this art is a method for improving an estimated physiological signal extracted from video images captured by a video camera of a handheld device.

### INCORPORATED REFERENCES

The following U.S. Patents, U.S. Patent Applications, and Publications are incorporated herein in their entirety by reference.

“A Video Acquisition System And Method For Monitoring A Subject For A Desired Physiological Function”, U.S. patent application Ser. No. 13/921,939, by Xu et al.

“Processing A Video For Spatial And Temporal Magnification With Minimized Image Degradation”, U.S. patent application Ser. No. 13/708,125, by Mestha et al.

### BRIEF SUMMARY

What is disclosed is a method for improving an estimated physiological signal extracted from video images captured by a video camera of a handheld device such as a smartphone, tablet, notebook, or a laptop. The handheld device has an illuminator along with a video camera for capturing video images of a region of interest such that a desired physiological function of a subject can be monitored. In one embodiment, a user positions the handheld device such that light reflected off the subject's region of interest is received by a sensor and analyzed to determine how a physiological signal extracted from video images captured by the video camera can be improved by an adjustment made to the device's illuminator. In response to that determination, the illuminator is adjusted with respect to intensity, spectrally, spatially, and/or temporally, such that a level of accuracy of a measurement of that physiological function is improved. Video images of the subject's region of interest can then be captured by the video camera of the handheld device and processed to extract a time-series signal from which a physiological signal corresponding to the desired physiological function can be extracted. The extracted physiological signal is used to monitor that physiological function for the subject.

Features and advantages of the above-described handheld apparatus will become readily apparent from the following detailed description and accompanying drawings.

### BRIEF DESCRIPTION OF THE DRAWINGS

The foregoing and other features and advantages of the subject matter disclosed herein will be made apparent from the following detailed description taken in conjunction with the accompanying drawings, in which:

FIG. 1 is a front view of one example handheld device capable of utilizing in wireless cellular network;

FIG. 2 is a back view of the handheld device of FIG. 1;

FIG. 3 is a right side view of the handheld device of FIG. 1;

FIG. 4 is a functional block diagram of the handheld device of FIGS. 1-3;

FIG. 5 is one example embodiment of the present method for improving a level of accuracy of a measurement of a desired physiological function obtained from video images captured by a video camera of the handheld device of FIGS. 1-4;

FIG. 6 is a continuation of the flow diagram of FIG. 5 with flow processing continuing with respect to node A; and

FIG. 7 shows one example signal processing system which may be wholly incorporated within the handheld device of FIGS. 1-4 wherein various aspects of the present method as described with respect to the flow diagrams hereof are implemented.

### DETAILED DESCRIPTION

What is disclosed is a handheld device for improving a physiological signal extracted from video images captured by a video camera of a handheld device.

### Non-Limiting Definitions

A “subject of interest” or simply “subject” refers to a human having a physiological function as described herein. Although the term “human”, “person” or “patient” may be used in this text, it should be appreciated that the subject may be something other than a human. Use of such terms is therefore not to be viewed as limiting the scope of the appended claims strictly to human subjects.

A “region of interest” refers to an area of the subject where a physiological signal can be obtained from processing video images captured by a video camera of a handheld device. A region of interest may be an area of the subject's exposed skin such as a face or chest area. Signals are extracted by processing that video to provide measurements of the subject's cardiac function.

A “handheld device” refers to a device such as a smartphone, tablet, notebook, and a laptop which is configured in a manner as disclosed herein to capture video images of a region of interest of a subject being monitored for a desired physiological function. The handheld device has a display screen and a video camera for capturing video images of a region of interest of a subject. The video camera can be a monochrome camera or a color camera sensitive to light in a visible wavelength range. The video camera can be an infrared camera sensitive to an infrared wavelength range. The video camera may be a hybrid device that captures video images in both the visible and infrared wavelength ranges. The video camera can be a multi/hyperspectral device, built into the phone or attached externally with a plug in cord such as the USB. The handheld device further has an adjustable illuminator which is integral to the handheld device. In other embodiments, the handheld device controls one or more adjustable illuminators which are external to the handheld device. In yet another embodiment, the illuminator is the display of the handheld device where images with different intensity levels, different spatial patterns, or different colors (spectra) can be displayed at different time intervals (temporal). For example, to extract heart rate, since the plethysmographic signal is high in the green band, device display can be tailored to exit more green light and suppress other wavelengths using images. In yet another embodiment, different spatial patterns are generated and projected on to the scene to extract depth information as in 3D imaging system with patterned illumination. The handheld device is configured to communicate any of: the physiological signals (e.g., photoplethysmographic signal & respiration signal), the desired physiological function (heart rate, respiration rate, pulse transition time etc.), and/or the video images to a local storage device or to a remote device over a network. The handheld device may further comprise, in whole or in part, a hardware module such as an ASIC with at least one processor for executing machine readable program instructions for analyzing video images such that a physiological signal corresponding to the desired physiological function can be extracted. Such a module may comprise software working alone or in conjunction with various hardware resources.

An “adjustable illuminator” refers to a light source which is either electronically, programmably, or manually adjustable with respect to any of: intensity of the source light being emitted by the illuminator, a spectral characteristic of the source light, a spatial variation of the light, or temporally by, for example, toggling the light ON/OFF to achieve a desired periodicity. Note that the aforementioned definition of “adjustable illuminator” encompasses display devices such as the LCD or AMOLED touchscreens of a handheld device. An amount of adjustment to be applied to the illuminator such that a level of accuracy of a measurement of the physiological function is improved can be determined in a variety of ways. The adjustment can be determined by simply analyzing light reflected off a surface of a region of interest and received by a sensor integral such as a light meter to the handheld device to determine how a measurement obtained from a physiological signal to be extracted from video can be improved, for example by increasing the amount of light. The amount of adjustment can also be determined by having already processed video images captured of a region of interest and analyzing a physiological signal obtained therefrom to determine how a measurement obtained from that extracted signal can be improved. A user may alternatively make a selection of a physiological function from a display screen of the handheld device and one or more adjustments particular to the selected physiological function are retrieved from a storage device or are otherwise received from a remote device over a network and applied to the illuminator.

A “physiological signal” refers to a signal that corresponds to a desired physiological function. A physiological signal is extracted from a time-series signal obtained from processing video images of a region of interest. Physiological signals may be generated in real-time from streaming video and displayed in real-time on a display of the handheld device or communicated in real-time to a remote device over a wired or wireless network. Physiological signals may be generated from one or more regions of interest from the single video or multiple videos (e.g., front and back camera to capture videos of person's face in the front of the smart phone and then the second person's face in the back of the smart phone) with a synchronized capture system.

A “time-series signal” is a signal of interest extracted from a video that contains meaningful data that relates to a desired physiological function with respect to time for which the subject is being monitored. In one embodiment, a time-series signal is formed by averaging pixel values within each region of interest identified and isolated in each image frame of the video. A time-series signal comprises signal segments. Signal segments having a same time interval are averaged together to obtain processed segments. Each of the processed signal segments are stitched together to obtain a continuous time-series signal. Systems and methods for isolating a time-series signal in a video are disclosed in the following US patent applications which are incorporated herein in their entirety by reference. “Continuous Cardiac Pulse Rate Estimation From Multi-Channel Source Video Data With Mid-Point Stitching”, U.S. patent application Ser. No. 13/871,728, by Kyal et al., and “Continuous Cardiac Signal Generation From A Video Of A Subject Being Monitored For Cardiac Function”, U.S. patent application Ser. No. 13/871,766, by Kyal et al. Motion induced artifacts in the physiological signals can be compensated for using the methods disclosed in: “Compensating For Motion Induced Artifacts In A Physiological Signal Extracted From A Single Video”, U.S. patent application Ser. No. 13/923,588, by Xu et al. which discloses a system and method for compensating for motion induced artifacts in physiological signals obtained from a single video captured by a single video imaging device of a subject being monitored for a desired physiological function. Methods for processing source video to identify a time-series signal within that video and modifying pixels associated with the identified signal such that the signals are visually enhanced upon video playback, as disclosed in: “Processing Source Video For Real-Time Enhancement Of A Signal Of Interest”, U.S. patent application Ser. No. 13/745,283, by Tanaka et al. The video signal may be processed to remove undesirable periodic signals and random background noise, as disclosed in: “Removing Environment Factors From Signals Generated From Video Images Captured For Biomedical Measurements”, U.S. patent application Ser. No. 13/401,207, by Mestha et al. Source video data captured using a video camera may be reconstructed such that certain information in the source data is visually emphasized during video playback, as disclosed in: “Filtering Source Video Data Via Independent Component Selection”, U.S. patent application Ser. No. 13/281,975, by Mestha et al.

A “physiological function” refers to either a respiratory or a cardiac function.

A “respiratory function” refers to the physiological function of the lungs. If the physiological function for which the subject is being monitored is a respiratory function then the physiological signal used to measure that physiological function is a respiratory signal.

A “respiratory signal” is a physiological signal obtained from having processed video image of a thoracic region of the subject. The respiratory signal can be analyzed to determine pulmonary volumes, minute ventilation, flow-volume loops, breathing pattern, and respiration rate. The respiratory signal may be used to determine occurrence condition related to any of Sudden Infant Death Syndrome, respiratory distress, respiratory failure, and pulmonary disease. Methods for extracting a respiratory signal from a time-series signal obtained from video images of a region of interest are disclosed in the following US patent applications which are incorporated herein in their entirety by reference. “Monitoring Respiration with a Thermal Imaging System”, U.S. patent application Ser. No. 13/103,406, by Xu et al. “Processing A Video For Tidal Chest Volume Estimation”, U.S. patent application Ser. No. 13/486,637, by Bernal et al. “Minute Ventilation Estimation Based On Depth Maps”, U.S. patent application Ser. No. 13/486,682, by Bernal et al. “Minute Ventilation Estimation Based On Chest Volume”, U.S. patent application Ser. No. 13/486,715, by Bernal et al. “Processing A Video For Respiration Rate Estimation”, U.S. patent application Ser. No. 13/529,648, by Bernal et al. “Respiratory Function Estimation From A 2D Monocular Video”, U.S. patent application Ser. No. 13/680,838, by Bernal et al. A system and method for generating flow-volume loops for respiratory function assessment is disclosed in: “Generating A Flow-Volume Loop For Respiratory Function Assessment, U.S. patent application Ser. No. 14/023,654, by Mestha et al.

A “cardiac function” refers to the physiological function of the heart. If the physiological function for which the subject is being monitored is a cardiac function then the physiological signal used to measure that physiological function is a cardiac signal.

A “cardiac signal” is a physiological signal obtained from having processed video image of a region of interest where a photoplethysmographic (PPG) signal of a subject can be effectively registered by a video camera. A PPG signal contains important information about the subject's cardiac function. The cardiac signal can be analyzed to determine cardiac output, pulse transit time, heart rate variability, and cardiac pulse frequency, vascular assessment, autonomic function, blood oxygen saturation, tissue viability etc. The cardiac signal may be used to determine occurrence condition related to any of cardiac arrhythmia, respiratory sinus arrhythmia, cardiac stress, cardiac failure, and heart disease. Methods for extracting a cardiac signal from a time-series signal obtained from video images of a region of interest are disclosed in the following U.S. patent applications which are incorporated herein in their entirety by reference. “Estimating Cardiac Pulse Recovery From Multi-Channel Source Data Via Constrained Source Separation”, U.S. patent application Ser. No. 13/247,683, by Mestha et al. “Deriving Arterial Pulse Transit Time From A Source Video Image”, U.S. patent application Ser. No. 13/401,286, by Mestha et al. “Video-Based Estimation Of Heart Rate Variability”, U.S. patent application Ser. No. 13/532,057, by Mestha et al. “Systems And Methods For Non-Contact Heart Rate Sensing”, U.S. patent application Ser. No. 13/247,575, by Mestha et al. “Continuous Cardiac Pulse Rate Estimation From Multi-Channel Source Video Data”, U.S. patent application Ser. No. 13/528,307, by Kyal et al. “Processing A Video For Vascular Pattern Detection And Cardiac Function Analysis”, U.S. patent application Ser. No. 13/483,992, by Mestha et al. “Subcutaneous Vein Pattern Detection Via Multi-Spectral IR Imaging In An Identity Verification System”, U.S. patent application Ser. No. 13/087,850, by Xu et a. “Determining Cardiac Arrhythmia From A Video Of A Subject Being Monitored For Cardiac Function”, U.S. patent application Ser. No. 13/532,128, by Mestha et al. “Method And Apparatus For Monitoring A Subject For Atrial Fibrillation”, U.S. patent application Ser. No. 13/937,740, by Mestha et al. “Method And Apparatus For Monitoring A Subject For Fractional Blood Oxygen Saturation”, U.S. patent application Ser. No. 13/937,949, by Mestha et al. “Method And Apparatus For Monitoring A Subject For Functional Blood Oxygen Saturation”, U.S. patent application Ser. No. 13/937,782, by Mestha et al. “System And Method For Determining Video-Based Pulse Transit Time With Time-Series Signals”, U.S. patent application Ser. No. 14/026,739, by Mestha et al.

A “storage device” refers to a device or system for storing data, images, formulae, machine readable program instructions, and the like. Storage devices include RAM, ROM, Cache Memory, CD-ROM, DVD, flash drives, hard drives, and other volatile or non-volatile media.

### Example Wireless Handheld Device

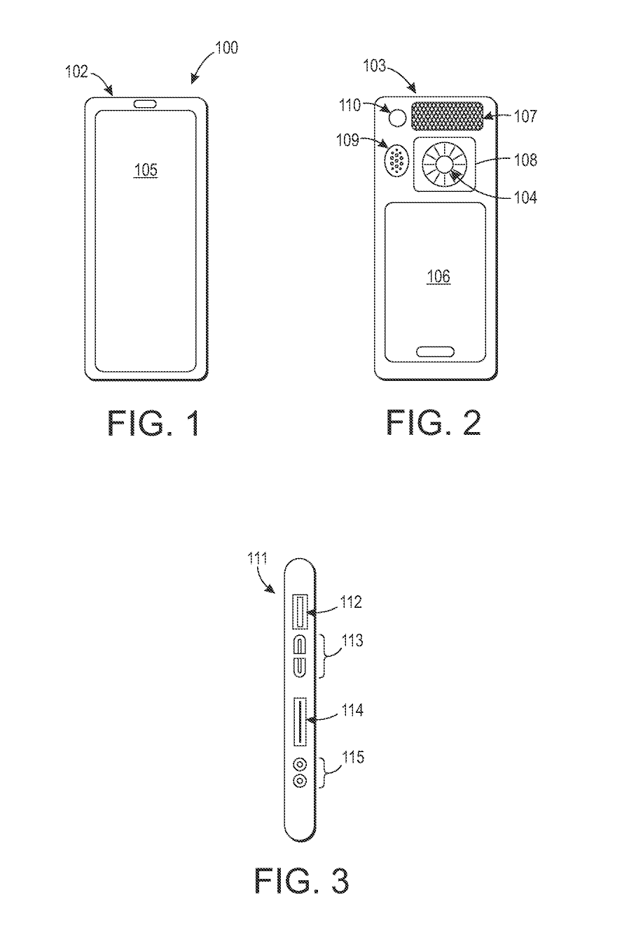

Reference is now being made to FIGS. 1-3 which illustrate various embodiment of one example handheld device 100 for performing various aspects of the present method. The handheld device 100 is a mobile cellular device which utilizes in wireless cellular network. FIG. 1 shows a front portion 102 of the wireless handheld device having a touchscreen display 105 which, in one embodiment, comprises an adjustable illuminator. The touchscreen is capable of displaying a virtual alphanumeric keyboard so that a user thereof can make entries or provide information, as needed. A user may use the touchscreen to make a selection as to a physiological function desired to be monitored. Text messages may be displayed on the display screen including video. Also displayed on the display of the handheld device may be a result of having analyzed the received light, a result of having analyzed the physiological signal, the time-series signal obtained from having processed video images captured by the video camera of the region of interest, an estimated strength of the time-series signal, and an estimated current level of accuracy for the physiological function being monitored. Also displayed on the display of the handheld device can be an image or video where the illumination of the display is used to compensate for the lack of illumination in the environment or provide an illumination with different spectral or temporal characteristics. Also displayed on the touchscreen display may be instructions for the user, such as, for instance, a position to hold the video camera relative to the region of interest, which region of interest to capture video of, a distance from a surface of the region of interest to hold the video camera, a number of frames of video images to capture for monitoring the selected physiological function, a time duration to capture video, an indication whether the desired physiological function can be accurately monitored, one or more boxed areas to contain the expected regions of interest (e.g., a rectangular box around the face, a rectangular box around the hand etc.). The front can also include a video camera when the subject is performing self-monitoring.

FIG. 2 shows a back portion 103 of the handheld device which includes a battery 106, an audio speaker 109 for playing an audio message or for playing a sound, a video camera 108 for capturing video images, a sensor 104 for receiving light, and an adjustable illuminator 110. FIG. 3 shows a right side portion 111 of the handheld device which includes a USB port 112, a volume control 113, a memory slot 114, and voice/audio jacks 115.

The handheld device functions to send email, text, audio, video, place a phone call, initiate an alert, vibrate by activating a motion-inducing component internal to the handheld device, and wirelessly activating remote devices such as external illuminators to perform its intended functions in accordance with the teachings hereof. Other embodiments of the handheld device have a slideably retractable keyboard with full alphanumeric (and special character) capabilities. A bottom (or top) portion of the device has a connector (not shown) to connect the device to a power source.

### Functional Block Diagram of a Handheld Device

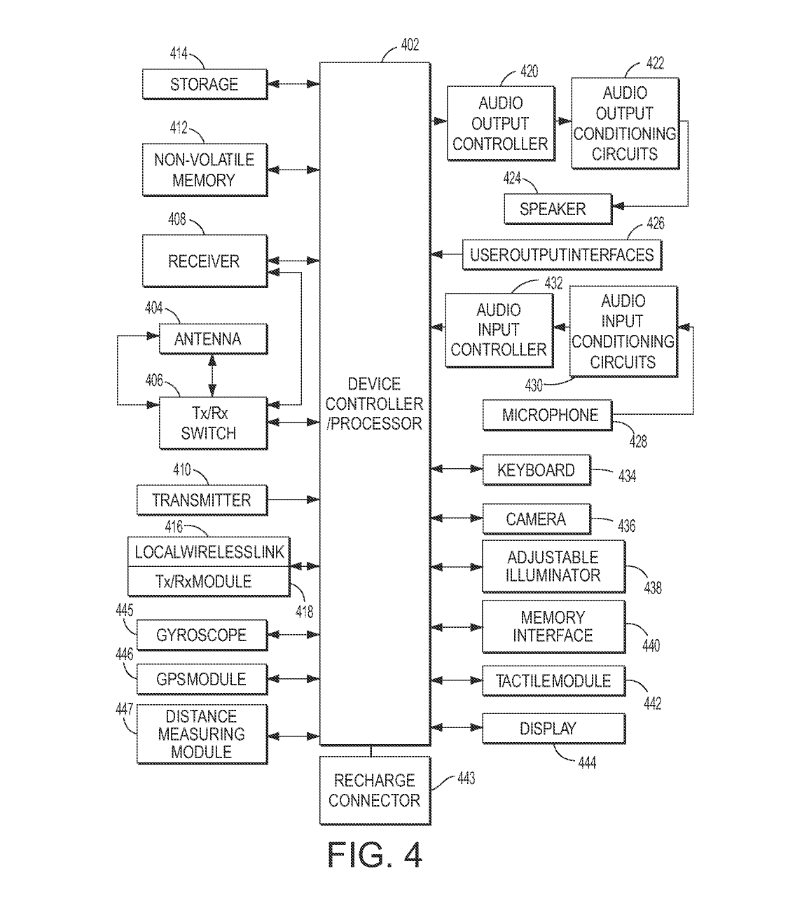

Reference is now being made to FIG. 4 which illustrates a functional block diagram of the example wireless handheld device. For brevity and clarity, the illustrated example omits details such as wires, screws, and other hardware that operatively connect the various elements of the mobile wireless device together. Such operative connective elements will be known to those skilled in the art. It should be appreciated that the described components conform to design constraints of a molded chassis having the form of a smartphone.

In FIG. 4, the wireless handheld device incorporates a device controller/processor 402 designed to control the various functions and operations intended to be performed thereby. The processor executes an operating system designed specifically for the device's hardware. Display module 444 controls a touch-sensitive screen designed to accept an input through a physical touching of the display surface by a fingertip or a stylus. When the display functions as the illuminator, the display module adjusts the illuminator with respect to any of: an intensity, spectral, spatial and/or temporal capability. The handheld device includes a video camera 436 for enabling a user to capture images of a region of interest. The video camera includes a lens assembly and a light sensing circuit (sensor) which is sensitive to a wavelength range of the illuminator. Such an imaging circuit may be used to analyze the light reflected off the subject's region of interest such that an adjustment can be determined. The camera is mounted to the chassis to enable image capture through an aperture in a front cover chassis. The camera is operated by one or more buttons on the wireless device. One of the buttons actuates the opening of the camera lens. Other buttons enable the camera to zoom-in/out or to focus more clearly on the object. The wireless device may also include device controllers for electronically adjusting zoom, focus, aperture, exposure, f-stop, and the like. Captured video images are stored to memory 412, storage device 414, or to a removable memory device which has been inserted into memory interface 440 which enables a user to plug a removable external device such a Micro-SD or other removable memory into the device.

Tactile interface 442 controls an oscillating cam that introduces a vibration sensation into the chassis. Global Positioning System (GPS) module 446 determines a location and/or velocity of the wireless handheld device via a triangulation of GPS satellites. The GPS module may compute location using a triangulation of cell towers in communication with the wireless device. Recharger connection 443 is configured to receive a complimentary plug of a transformer and a circuit in communication therewith receives a relatively small electrical charge from the transformer device and distributes that charge to the battery. Distance measuring module 447 functions to obtain a measurement of a distance from the handheld device to a surface of the region of interest. The distance measuring device may comprise, for example, a laser pointer which emits a narrow beam of light directed at a point of aim and which has a sensor for detecting a reflection of that beam off a surface. Machine readable program instructions are executed by a processor or by a specialized circuit such as an ASIC which calculates distance. The distance may further comprise a set of real-world coordinates in (X,Y,Z) relative to a rotational position of the handheld device as determined by gyroscope 445 which provides information with respect to a tilt of the device, typically relative to a horizontal axis. Rotational position may be used to determine whether a pose of the camera, relative to the region of interest, is correct or is otherwise adequate given a selected physiological function. Messages provided to the user may instruct the user to change the position of the camera by, for example, instructing the user to move the camera closer to or farther away from the region of interest, or to change an angle of the camera with respect to the surface.

Controller 402 facilitates the sending and receiving of wireless communication signals. The controller implements the baseband functions of mobile voice/data communication protocols as well as higher-level messaging protocols such as SMS and MMS. The controller also implements the baseband functions of local area voice and data protocols including Bluetooth. In receive mode, the device controller 402 communicatively couples antenna 404 through transmit/receive (Tx/Rx) switch 406 to receiver 408. The receiver decodes the received wireless signals and provides the decoded signals to the processor. In transmit mode, the device controller 402 communicatively couples the antenna through Tx/Rx switch 406 to transmitter 410 which transmits the communication signals. Local wireless link 416 allows the handheld device to communicate with other wireless devices without using the wireless communication network. The local wireless link may, for example, enable an embodiment of the handheld device configured with Bluetooth, RF, Infrared Data Access (IrDA), and other wireless link technologies, to operatively control one or more adjustable illuminators which are external to the handheld device. Tx/Rx module 418 allows the device to transmit/receive communication signals to/from other similarly configured devices.

The wireless device also includes non-volatile storage 414 for storing data, applications, software tools, and the like. Variables, formulas, tables, grids, maps with pre-defined positional points may be stored/retrieved from storage 414 or non-volatile memory 412 as are needed to perform their intended functions.

The wireless handheld device includes an audio output controller 420 that receives audio signals and sends audio signals to audio output conditioning circuit 422 which perform various conditioning functions such as noise filtering and/or improving the audio signal prior to providing that signal to speaker 424. User output interface 426 is a headphone jack, for instance. Microphone 428 enables a user to input audio into the device. Audio input controller 432 receives audio signals and sends signals to device controller 402 for further processing depending on the nature of the operation intending on being performed on those audio signals. Keyboard 434 (or keypad) effectuates an input by the user. Such a keyboard may take the form of a qwerty keyboard, or a likeness thereof and may further include a joystick (or a joystick-like feature) having a plurality of ranges of motion in different axes thereby allowing a user thereof to navigate a hierarchy of selectable menu options displayed thereon.

It should be appreciated that other functionality of any of these features may be controlled by software applications stored in memory which provide executable machine readable program instructions to a central processor. One or more of the components designed into any of the various electronic circuitry associated with any of the above-described features may further be controlled by an ASIC or other application specific device components. It should be understood that the embodiments shown are not to be viewed as limiting the scope of the appended claims solely to the illustrations provided.

### Example Flow Diagram

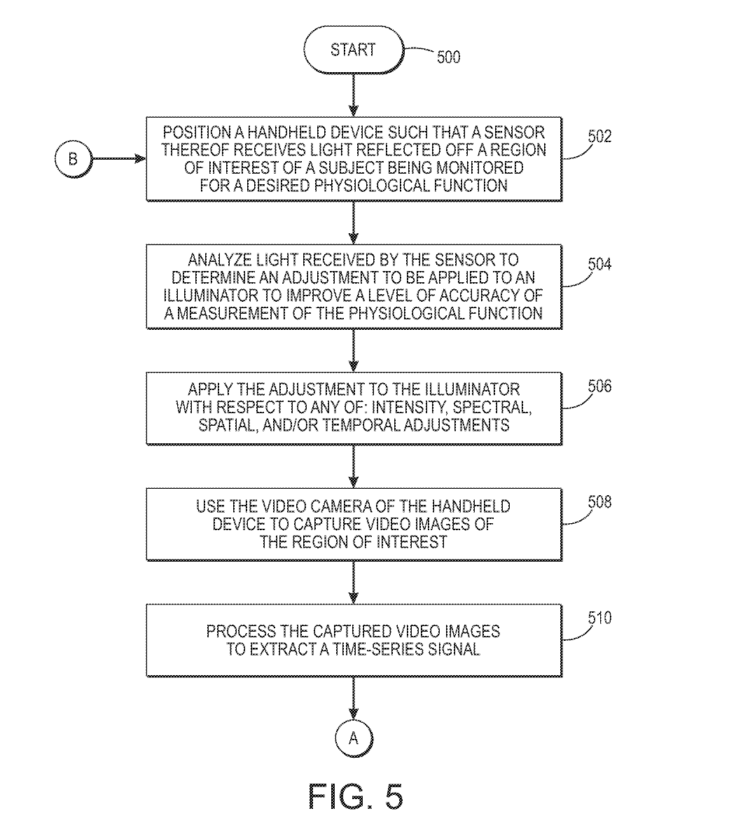

Reference is now made to the flow diagram of FIG. 5 which illustrates one example embodiment of the present method for improving a level of accuracy of a measurement of a desired physiological function obtained from video images captured by a video camera of a handheld device. Flow processing begins at step 500 and immediately proceeds to step 502.

At step 502, position a handheld device such that a sensor receives light reflected off a region of interest of a subject being monitored for a physiological function. The handheld device is configured with at least one illuminator that is adjustable with respect to intensity, spectrally, spatially, and temporally.

At step 504, analyze light received by the sensor to determine an adjustment to be applied to the illuminator to improve a level of accuracy of a measurement of a desired physiological function. Adjustments to be applied to the illuminator(s) are determined from analyzing a physiological signal obtained from having processed video images of the subject's region of interest such that a level of accuracy of a measurement of the desired physiological function is improved. Alternatively, adjustments to be applied to the illuminator(s) are retrieved from a storage device or received from a remote device over a network in response to a user selection of a particular physiological function on a touchscreen display screen of the handheld device.

At step 506, apply the adjustment to the illuminator.

At step 508, use the video camera to capture video images of the region of interest.

At step 510, process the captured video images to extract a time-series signal.

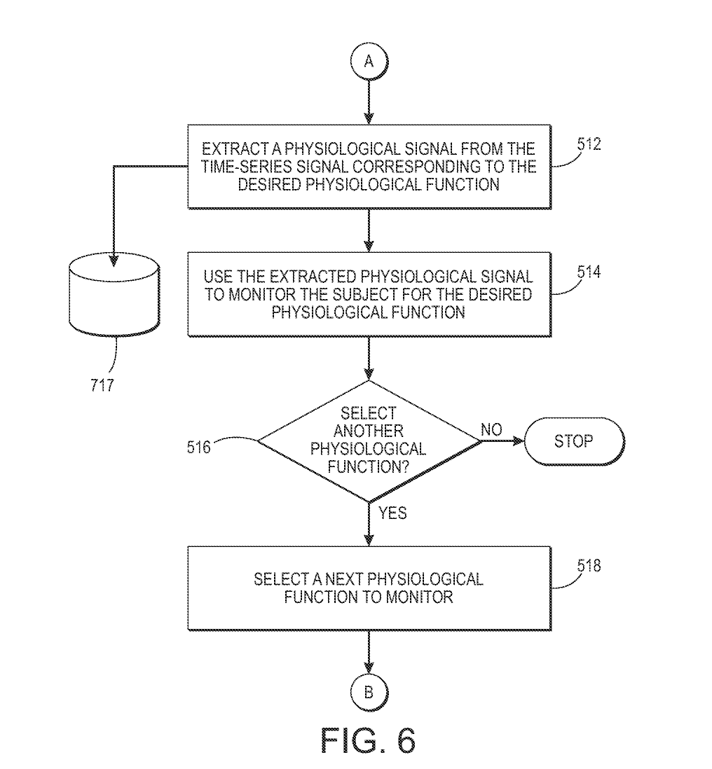

Reference is now being made to the flow diagram of FIG. 6 which is a continuation of the flow diagram of FIG. 5 with flow processing continuing with respect to node A.

At step 512, extract a physiological signal from the time-series signal which corresponds to the desired physiological function. The extracted physiological signal may be stored to storage device 717.

At step 514, use the extracted physiological signal to monitor the subject for the desired physiological function. The physiological function may be one or both of a cardiac function or a respiratory function and may be examined by a medical practitioner such that the subject's physiological function can be properly assessed. In one embodiment, the physiological signal is examined by an artificial intelligence algorithm to determine whether an alert exists due to a respiratory or cardiac failure. If so then an alert signal is sent by the handheld device to a medical practitioner or a medical response center. The alert signal may comprise, for example, an alarm or a message flashing on a monitor in a remote location such as a hospital, physician's office, or medical kiosk. Such a notification can take the form of a text message sent to a nurse, family physician, cardiologist, or respiratory therapist. Such a notification may comprise a pre-recorded voice, text, or video message indicating the nature of the alert condition and may further contain information about the patient such as name, address, contact information, current location via GPS coordinates, and the like. Such a notification can take any of a variety of forms and would depend on the particular environment wherein the teachings hereof find their intended uses.

At step 516, a determination is made whether another physiological function is desired to be monitored. If so then, at step 518, a next physiological function is selected for monitoring and processing continues with respect to node B wherein the steps repeat. In this embodiment, further processing otherwise stops.

In another embodiment, a decision is made whether to capture more video images of the same region of interest such that another physiological signal can be obtained for the current physiological function. In yet another embodiment, a decision is made whether to select or re-adjust the illuminator in anticipation of recapturing new video images of the region of interest such that another physiological signal can be obtained therefrom. The user may be instructed to adjust a position of the video camera and/or the illuminator relative to the region of interest in anticipation of new video images being captured. The user may be instructed to capture video images of another region of interest.

It should be appreciated that the flow diagrams hereof are illustrative. One or more of the operative steps may be performed in a differing order. Other operative steps may be added, modified, enhanced, condensed, integrated, or consolidated. Such variations are intended to fall within the scope of the appended claims. All or portions of the flow diagrams may be implemented partially or fully in hardware executing machine readable program instructions.

### Example Networked System

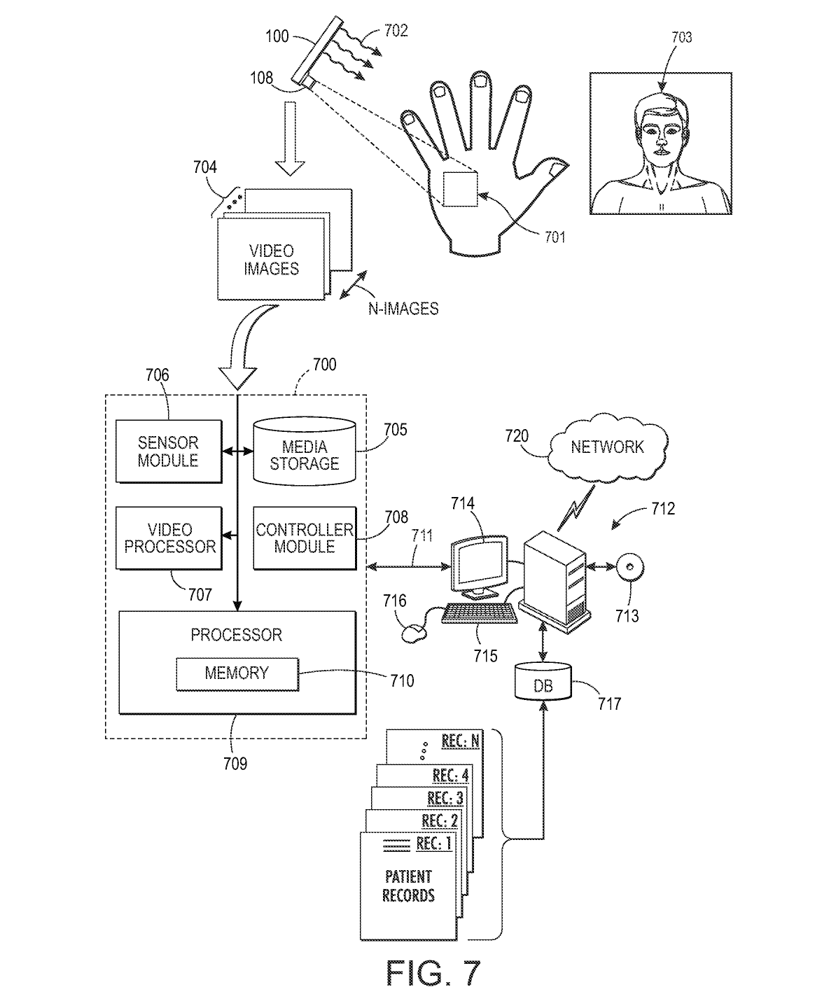

Reference is now being made to FIG. 7 which illustrates a block diagram of one example signal processing system 700 wherein various aspects of the teachings hereof are performed.

In FIG. 7, video camera 108 of the handheld device 100 of FIG. 2 is shown capturing video images of a region of interest 701 illustrated as an area on the back of a subject's left hand where a PPG signal can be registered. Also shown is a second region of interest 703 containing the upper chest, neck, and facial area of the subject for those applications where images of two regions are interest are captured for determination of, for instance, a pulse transit time between two points. The handheld device has an adjustable illuminator, shown projecting source light 702 onto the subject's hand. It should be appreciated that, although not illustrated, source light 702 may also be projected onto region of interest 703. The illuminator may be an external light source which is electronically, programmably, and manually adjustable, or one that is placed in communication with the handheld device and thus controllable by the handheld device. Video shown as a plurality of images (collectively at 704) are communicated to an image processing system 700 which is internal to the handheld device. The video images are initially stored to storage device 705.

Sensor Module 706 senses light reflected off the region of interest (as received by the lens of the video camera) and determines an adjustment to be made to the illuminator to improve a level of accuracy of a measurement of the physiological function previously selected or otherwise identified by a user. In one embodiment, sensor Module 706 determines the adjustment by having processed the video images stored in the storage device 705 and by analyzing the physiological signal extracted therefrom. Video Processor 707 processes the image frames 704 of the captured video to isolate the region of interest and to process pixels in the isolated region obtain a time-series signal. A physiological signal that corresponds to the desired physiological function is extracted from the time-series signal. For extracting pulse transit time, at least two time-series signals are generated from proximal and distal regions. One example of the proximal and distal regions of interest is the face region and front of the hand respectively. For such applications, both regions of the interest have to be captured simultaneously.

Controller 708 functions to apply the adjustment determined by the Sensor Module 706 to the adjustable illuminator. Controller Module 708 may further communicate instructions to the patient to move the video camera and/or the illuminator relative to the region of interest. Other instructions may also be communicated. The Controller communicates the obtained physiological signals 711 to the workstation 712 so that those signals can be displayed on a display device thereof to effectuate a medical diagnosis for the subject based upon those signals.

Processor 709 retrieves machine readable program instructions from Memory 710 to facilitate the functionality of any of the modules of the signal processing system 700. The processor, operating alone or in conjunction with other processors and memory, may be configured to assist or otherwise facilitate the functionality of any of the processors and modules of system 700.

A computer case of the workstation 712 houses various components such as a motherboard with a processor and memory, a network card, a video card, a hard drive capable of reading/writing to machine readable media 713 such as a floppy disk, optical disk, CD-ROM, DVD, magnetic tape, and the like, and other software and hardware needed to perform the functionality of a computer workstation. The workstation further includes a display device 714, such as a CRT, LCD, or touchscreen device, for displaying information, video, measurement data, computed values, medical information, results, including distances, locations, and the like. A user can view that information and make a selection from menu options displayed thereon. Keyboard 715 and mouse 716 effectuate a user input or selection.

It should be appreciated that the workstation has an operating system and other specialized software configured to display alphanumeric values, menus, scroll bars, dials, slideable bars, pull-down options, selectable buttons, and the like, for entering, selecting, modifying, and accepting information needed for processing video images, and for enabling a medical practitioner to perform a medical diagnosis based upon the extracted physiological signals. In other embodiments, results are communicated to one or more medical practitioners in various locations for their review. A practitioner may further communicate instructions back to the user via the handheld device, depending on the implementation. A user or technician may use the user interface of the workstation to identify regions of interest, set parameters, select image portions and/or regions of images for processing. These selections may be stored/retrieved in a storage devices 713 and 717. Default settings and initial parameters can be retrieved from either the storage devices, as needed.

The workstation implements a database in storage device 717 wherein patient records are stored, manipulated, and retrieved in response to a query. Such records, in various embodiments, take the form of patient medical history stored in association with information identifying the patient along with information regarding the region of interest, camera settings, wavelengths of interest, positioning and locational data associated with given physiological functions, mathematical representations and data values used to process the time-series signals to obtain the physiological signals for a medical diagnosis, adjustments that can be made to various types of illuminators, and the like. Although the database is shown as an external device, the database may be internal to the workstation mounted, for example, on a hard disk therein.

Although shown as a desktop computer, it should be appreciated that the workstation can be a laptop, mainframe, or a special purpose computer such as an ASIC, circuit, or the like. The embodiment of the workstation of FIG. 7 is illustrative and may include other functionality known in the arts. Any of the components of the workstation 712 may be placed in communication with the signal processing system 700 or any devices in communication therewith. Any of the modules and processing units of system 700 can be placed in communication with storage device 717 or computer readable media 713 and may store/retrieve therefrom data, variables, records, parameters, functions, and/or machine readable/executable program instructions, as needed to perform their intended functions.

Each of the modules of the system 700 may be placed in communication with one or more remote devices over network 720. It should be appreciated that some or all of the functionality performed by any of the modules or processing units of system 700 can be performed, in whole or in part, by the workstation placed in communication with the handheld device 100 over network 720. The embodiment shown is illustrative and should not be viewed as limiting the scope of the appended claims strictly to that configuration. Various modules may designate one or more components which may, in turn, comprise software and/or hardware designed to perform the intended function.

### Various Embodiments

The teachings hereof can be implemented in hardware or software using any known or later developed systems, structures, devices, and/or software by those skilled in the applicable art without undue experimentation from the functional description provided herein with a general knowledge of the relevant arts. One or more aspects of the methods described herein are intended to be incorporated in an article of manufacture. The article of manufacture may be shipped, sold, leased, or otherwise provided separately either alone or as part of a product suite or a service.

It will be appreciated that the above-disclosed and other features and functions, or alternatives thereof, may be desirably combined into other different systems or applications. Presently unforeseen or unanticipated alternatives, modifications, variations, or improvements may become apparent and/or subsequently made by those skilled in this art which are also intended to be encompassed by the following claims. The teachings of any publications referenced herein are each hereby incorporated by reference in their entirety.

What is claimed is:

1. A method for improving a level of accuracy of a measurement of a desired physiological function obtained from video images captured by a video camera of a handheld device, the method comprising:
determining an adjustment to be applied to at least one illuminator of a handheld device having a video camera for capturing video images of a region of interest of a subject being monitored for a desired physiological function; and
adjusting, in response to said determination, at least one of said illuminators with respect to any of: intensity, spectrally, spatially, and temporally, such that a level of accuracy of a measurement of said physiological function is improved.

2. The method of claim 1, wherein said video camera is sensitive to any of: a visible wavelength range, an infrared wavelength range, and a combination of visible and infrared wavelength ranges.

3. The method of claim 1, wherein any of said illuminators is at least one of: electronically, programmably, and manually adjustable.

4. The method of claim 1, wherein determining said adjustment comprises any of:
analyzing a physiological signal obtained from having processed video images of said region of interest;
analyzing light received by a sensor integral to said handheld device, said received light having been reflected off a surface of said region of interest; and
in response to a user selection of a physiological function from a display screen of said handheld device, performing any of:
calculating said adjustment from said analyzed light captured by an on-device camera;
retrieving said adjustment from a storage device of said handheld device; and
receiving said adjustment from a remote device over a network.

5. The method of claim 4, wherein, in response to said adjustment having been applied, further comprising:
using said video camera to capture video images of said region of interest;
processing said captured video images to extract a time-series signal;
processing said time-series signal to extract a physiological signal corresponding to said desired physiological function; and
using said physiological signal to monitor said desired physiological function.

6. The method of claim 5, wherein said physiological function is a cardiac function, and said physiological signal is a cardiac signal, further comprising analyzing said cardiac signal to determine any of: cardiac output, pulse transit time, heart rate variability, and cardiac pulse frequency.

7. The method of claim 6, further comprising using said cardiac signal to determine a condition related to any of: cardiac arrhythmia, respiratory sinus arrhythmia, cardiac stress, cardiac failure, and heart disease.

8. The method of claim 5, wherein said physiological function is a respiratory function and said physiological signal is a respiratory signal, further comprising analyzing said respiratory signal to determine any of: pulmonary volumes, minute ventilation, flow-volume loops, breathing pattern, and respiration rate.

9. The method of claim 8, further comprising using said respiratory signal to determine a condition related to any of: Sudden Infant Death Syndrome, respiratory distress, respiratory failure, and pulmonary disease.

10. The method of claim 5, further comprising communicating any of: said physiological signal, said physiological function, and said video images to any of: a storage device, and a remote device over a network.

11. The method of claim 1, wherein at least one of said adjustable illuminators is any of: an illuminated display screen of said handheld device, a light source integral to said handheld device, and an external illuminator controllable by said handheld device.

12. The method of claim 1, further comprising changing an image or a video sequence displayed on a display of said handheld device with respect to any of: intensity, spectrally, and temporally.

13. The method of claim 1, wherein said handheld device is any of: a smartphone, tablet, notebook, and a laptop.

14. The method of claim 5, further comprising displaying on a display of said handheld device any of: a result of having analyzed said received light, a result of having analyzed said physiological signal, said time-series signal, a strength of said time-series signal, said physiological function, an estimated current level of accuracy for said desired physiological function, a position to hold said video camera, a location of said region of interest to capture video of, a distance from a surface of said region of interest to hold said video camera, a number of frames of video images to capture for monitoring said physiological function, a time duration to capture video, an indication whether said desired physiological function can be accurately monitored, and a notification for said user.

15. The method of claim 12, wherein said notification comprises said handheld device doing any of: playing an audio message, making a sound, displaying a text message, sending an email, sending a text message, placing a phone call, playing a video, initiating an alert, vibrating by activating a motion-inducing component internal to said handheld device, blinking a light, and wirelessly activating a remote device to perform an intended function.

16. A handheld device which improves an accuracy of a measurement of a desired physiological function, the device comprising:
at least one adjustable illuminator for projecting source light at a desired wavelength of interest;
a video camera for capturing video images of a region of interest of a subject being monitored for a desired physiological function, said video camera being sensitive to a wavelength range of said light source; and
a processor executing machine readable instructions for:
determining an adjustment to be applied to at least one illuminator; and
adjusting, in response to said determination, at least one of said illuminators with respect to any of: intensity, spectrally, spatially, and temporally, such that a level of accuracy of a measurement of said physiological function is improved.

17. The device of claim 16, wherein said video camera is sensitive to any of: a visible wavelength range, an infrared wavelength range, and a combination of visible and infrared wavelength ranges.

18. The device of claim 16, wherein any of said illuminators is at least one of: electronically, programmably, and manually adjustable.

19. The device of claim 16, wherein determining said adjustment comprises any of:
analyzing a physiological signal obtained from having processed video images of said region of interest;
analyzing light received by a sensor integral to said handheld device, said received light having been reflected off a surface of said region of interest; and
in response to a user selection of a physiological function from a display screen of said handheld device, performing any of:
calculating said adjustment from said analyzed light captured by an on-device camera;
retrieving said adjustment from a storage device of said handheld device; and
receiving said adjustment from a remote device over a network.

20. The device of claim 19, wherein, in response to said adjustment having been applied, further comprising:
using said video camera to capture video images of said region of interest;
processing said captured video images to extract a time-series signal;
processing said time-series signal to extract a physiological signal corresponding to said desired physiological function; and
using said physiological signal to monitor said desired physiological function.

21. The device of claim 20, wherein said physiological function is a cardiac function, and said physiological signal is a cardiac signal, further comprising analyzing said cardiac signal to determine any of: cardiac output, pulse transit time, heart rate variability, and cardiac pulse frequency.

22. The device of claim 21, further comprising using said cardiac signal to determine a condition related to any of: cardiac arrhythmia, respiratory sinus arrhythmia cardiac stress, cardiac failure, and heart disease.

23. The device of claim 20, wherein said physiological function is a respiratory function and said physiological signal is a respiratory signal, further comprising analyzing said respiratory signal to determine any of: pulmonary volumes, minute ventilation, flow-volume loops, breathing pattern, and respiration rate.

24. The device of claim 23, further comprising using said respiratory signal to determine a condition related to any of: Sudden Infant Death Syndrome, respiratory distress, respiratory failure, and pulmonary disease.

25. The device of claim 20, further comprising communicating any of: said physiological signal, said physiological function, and said video images to any of: a storage device, and a remote device over a network.

26. The device of claim 16, wherein at least one of said adjustable illuminators is any of: an illuminated display screen of said handheld device, a light source integral to said handheld device, and an external illuminator controllable by said handheld device.

27. The device of claim 16, further comprising changing an image or a video sequence displayed on a display of said handheld device with respect to any of: intensity, spectrally, and temporally.

28. The device of claim 16, wherein said handheld device is any of: a smartphone, tablet, notebook, and a laptop.

29. The device of claim 20, further comprising displaying on a display of said handheld device any of: a result of having analyzed said received light, a result of having analyzed said physiological signal, said time-series signal, a strength of said time-series signal, said physiological function, an estimated current level of accuracy for said desired physiological function, a position to hold said video camera, a location of said region of interest to capture video of, a distance from a surface of said region of interest to hold said video camera, a number of frames of video images to capture for monitoring said physiological function, a time duration to capture video, an indication whether said desired physiological function can be accurately monitored, and a notification for said user.

30. The device of claim 29, wherein said notification comprises said handheld device doing any of: playing an audio message, making a sound, displaying a text message, sending an email, sending a text message, placing a phone call, playing a video, initiating an alert, vibrating by activating a motion-inducing component internal to said handheld device, blinking a light, and wirelessly activating a remote device to perform an intended function.
